(19) United States
(12) Patent Application Publication
(10) Pub. No.: US 2009/0271152 A1
(43) Pub. Date: Oct. 29, 2009

(54) Load testing mechanism for server-based applications

(75) Inventor: Tim Barrett, Nth Ryde (AU)

Correspondence Address: Kramer & Amado, P.C., 1725 Duke Street, Suite 240, Alexandria, VA, 22314, US

(73) Assignee: ALCATEL, Paris (FR)

(21) Appl. No.: 12/149,138

(22) Filed: Apr. 28, 2008

(51) Int. Cl. G06F 15/00

(52) U.S. Cl. 702/186

(57) ABSTRACT

In various exemplary embodiments, a method of monitoring performance of a server and a related computer-readable medium include one or more of the following: placing a load agent on at least one server; maintaining a load on the server using the load agent, wherein the load corresponds to at least one predetermined performance parameter of the server; monitoring the at least one predetermined performance parameter on the server; and gathering performance information while the load agent is monitoring the server. In various exemplary embodiments, the performance parameters include CPU usage, memory usage, network load, and disk performance. Thus, various exemplary embodiments enable a precise determination of the effect on application requests received by the server when the server is under a specific load.

### BACKGROUND OF THE INVENTION

1. Field of the Invention

This invention relates generally to load testing of computer servers, and, more particularly, to a method of generating artificial load conditions directly on servers in order to facilitate testing of application performance under adverse conditions.

2. Description of the Related Art

Load testing is the process of creating demand on a system or device and measuring its response. Such testing is often needed for servers on complex computer systems. High volumes of data on such systems can overwhelm servers, so it is often essential to perform testing in order to identify a problem before it impacts a vital application. Tests may determine the maximum capacity of the overall system, spot potential scalability problems, identify bottlenecks, and determine how well the servers perform under load. For example, load testing can identify the maximum number of users that may simultaneously use a server without producing significant degradation of its performance.

When load testing complex client-server application platforms, test data is collected to determine how the individual servers that make up the application platform perform under load. Thus, a testing device must somehow generate a load to simulate various clients connecting to the system. In a typical load testing scenario for a client-server application, devices are used to emulate a large number of clients connecting to the servers, and the performance of the server is monitored to determine the amount of load that number of clients produces. Server load may be measured in terms of CPU utilization, or by many other metrics that are impacted when client load is being generated on the server. These metrics may include memory utilization, input/output capacity, network load, and any other performance parameter.

For high performance applications, however, the requirement to generate a load through client connections can be costly or difficult to achieve, and there may be requirements to test the server from a different perspective, such as a situation where some external factor causes load on the server independently from the application being tested. One example of such an external factor may be a rogue process or virus on the server that causes the CPU load to increase dramatically. Current load generation mechanisms generate load on the server externally by generating connections, but in this case there would be a need to generate CPU load independently of the application.

Accordingly, there is a need to create artificial events internally on the server itself in order to control conditions on that server, independent of the application being tested. There is a further need to generate a load that is completely controllable in order to get the precise load profile required for the particular testing, thereby allowing users to accurately predict the effect of load on the performance of an application. Furthermore, there is a need for combining multiple types of loads on a server, such that the performance of the application under varying conditions can be determined and the particular cause of a performance decrease or failure can be isolated.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations, and improvements herein shown and described in various exemplary embodiments.

### SUMMARY OF THE INVENTION

In light of the present need for a self-contained, autonomous agent that internally generates load on the server itself, a brief summary of various exemplary embodiments is presented. Some simplifications and omissions may be made in the following summary, which is intended to highlight and introduce some aspects of the various exemplary embodiments, but not to limit its scope. Detailed descriptions of preferred exemplary embodiments adequate to allow those of ordinary skill in the art to make and use the inventive concepts will follow in later sections.

In various exemplary embodiments, a method of monitoring performance of a server comprises the steps of placing a load agent on at least one server; maintaining a load on the server using the load agent, wherein the load corresponds to at least one predetermined performance parameter of the server; monitoring the predetermined performance parameter on the server; and gathering performance information while the load agent is monitoring the server.

In various exemplary embodiments, the method may further comprise the step of using an agent controller to configure a test scenario having the parameter. This agent controller may be located externally from the server and may be used to start the load agent. The parameter may be CPU usage, memory usage, disk input and output performance, network load, or any other performance parameter. For CPU usage testing, the agent may start and stop executable threads. For memory usage testing, the agent may add and delete data structures from memory. Furthermore, the agent may maintain the parameter at a first level during a first time period and at a second level during a second time period.

In various exemplary embodiments, a system for load testing at least one server comprises at least one server, each server comprising a load agent configured to maintain a load on the server based on parameters specified by a user; and an agent controller configured to allow the user to externally control a load testing scenario on the server. The load on the server may correspond to at least one predetermined performance parameter of the server. The system may further comprise performance measurement tools configured to gather information regarding the parameter.

In various exemplary embodiments, a computer-readable medium encoded with instructions for monitoring performance of a server may comprise instructions for placing a load agent on at least one server; instructions for maintaining a load on the server using the load agent, wherein the load corresponds to at least one predetermined performance parameter of the server; instructions for monitoring the parameter on the server; and instructions for gathering performance information while the load agent is monitoring the server.

In various exemplary embodiments, the computer-readable medium may further comprise instructions for using an agent controller to configure a test scenario having the parameter and instructions for using the agent controller to start the load agent. The parameter may be CPU usage, memory usage, disk input performance, disk output performance, or any other performance characteristic as appropriate. The computer-readable medium may further comprise instructions for maintaining the parameter at a first level during a first time period and at a second level during a second time period, or many more according to the requirements of the tests. For each time period, the mixture of load generation characteristics may also be varied such that, for example, the initial test would generate only a CPU load, then a CPU load with the addition of a heavy disk input/output load, followed by heavy network load, etc.

In summary, the system allows for precise control of server load testing. Rather than having an external testing device, a load agent on the server itself dynamically adjusts the load to accurately track a test scenario. Instead of indirectly simulating virtual users, the load agent generates load levels that directly correlate to actual performance characteristics on the server.

### BRIEF DESCRIPTION OF THE DRAWINGS

In order to better understand various exemplary embodiments, reference is made to the accompanying drawings, wherein:

FIG. 1 is a schematic diagram of a system including a load agent installed on a server;

FIG. 2 is a flowchart showing the steps of a server load testing process;

FIG. 3 is a flowchart showing the implementation of a feedback loop within the process of FIG. 2; and

FIG. 4 shows an exemplary test of CPU usage.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

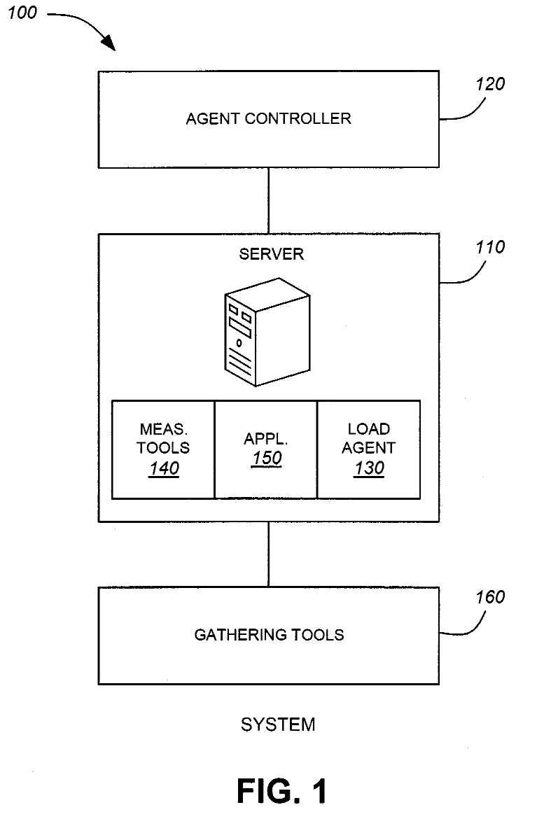

FIG. 1 is a schematic diagram of an exemplary system 100 including a load agent 130 installed on a server 110. In various exemplary embodiments, system 100 includes server 110, agent controller 120, load agent 130, performance measurement tools 140, application 150, and performance gathering tools 160.

In various exemplary embodiments, agent controller 120 allows user control of a plurality of load agents, including load agent 130. Thus, agent controller 120 may be a combination of software and/or hardware that allows a user to specify load testing parameters for load agent 130. It should be apparent that these parameters may be any values related to computer performance, including, but not limited to, CPU usage, memory usage, and disk performance. Furthermore, it should also be noted that agent controller 120 is optional, as a user may directly enter parameters for testing into load agent 130 at server 110.

In various exemplary embodiments, agent controller 120 is located on an external platform. This platform may be, for example, an Internet Protocol Television (IPTV) software platform. Such platforms comprise many video servers that perform different functions. For example, real-world scenarios for these servers may involve unequal usage of standard-definition (3.75 Mbps) and high-definition (19+ Mbps) video streams. Video quality is a major issue for IPTV, as consumers would be unlikely to accept this new technology unless it reliably provided superior video quality on a consistent basis.

By utilizing agent controller 120 in combination with load agent 130, load testing of server 110 may simulate a variety of traffic conditions, measuring how heavy traffic can result in lowered video quality. As an example, a video server that processes incoming video streams for encryption or retransmission will provide unreliable video streams if the CPU usage exceeds a threshold or available memory is low. Thus, a user may direct agent controller 120 to send test parameters to load agent 130 to set the CPU level of server 110 and monitor application performance while the CPU is maintained at the specified level.

As illustrated in FIG. 1, system 100 includes a single server 110 with a single load agent 130. It should be apparent, however, that system 100 may include plural servers, with each server 110 including a similar load agent 130. Regardless of the number of servers, load agent 130 is located on server 110 rather than being disposed at a remote location.

In various exemplary embodiments, load agent 130 applies a specified load to server 110 based on the parameters received from a user. Thus, load agent 130 may receive control signals from agent controller 120 under the control of the user. Alternatively, as described above, a user may directly specify testing parameters for load agent 130 without the use of agent controller 120.

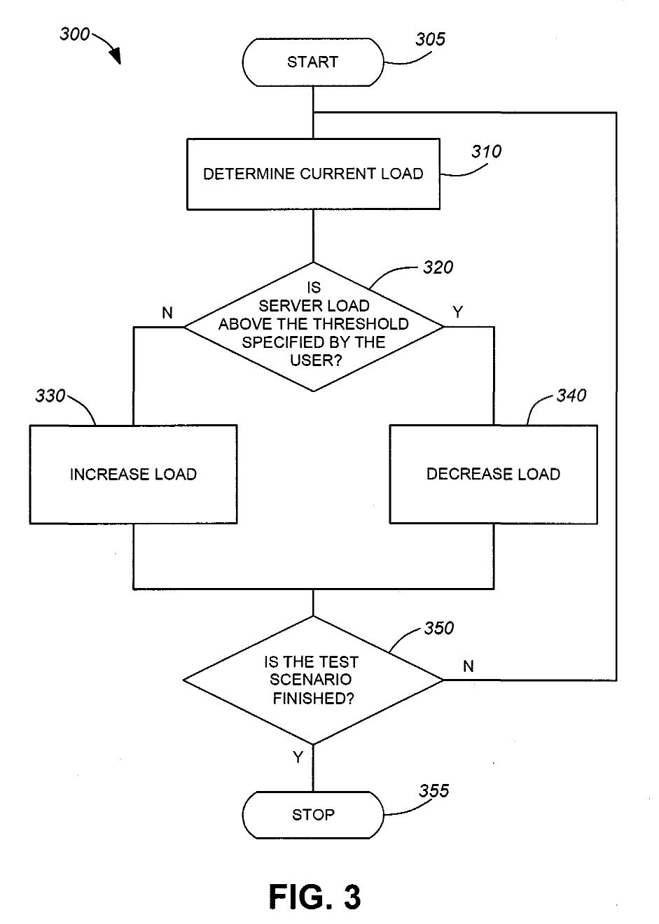

Based on the parameters received from the user, load agent 130 applies and maintains the predetermined load on server 110. Accordingly, load agent 130 may apply and maintain a load on the CPU, memory, hard disk, network, or any other components of server 110. As described in further detail below with reference to FIG. 3, load agent 130 includes a feedback loop that receives measurements of the current load on server 110 and adjusts the load accordingly.

In addition to load agent 130, server 110 comprises other elements related to load testing. For example, performance measurement tools 140 cooperate with load agent 130 to exchange data regarding the current performance of server 110. Performance measurement tools 140 may be separate to or included as part of the load agent, as this function is required for feedback of the current system load to the load agent. Thus, for example, performance measurement tools 140 may monitor CPU, memory, network utilization, or hard disk usage, and send information regarding the current values to load agent 130.

In various exemplary embodiments, performance gathering tools 160 are coupled to server 110 to receive results from performance measurement tools 140. In this way, useful information from the test scenario can be forwarded for further processing. By providing controllable test conditions, various exemplary embodiments permit performance gathering tools 160 to accurately quantify the impact of simulated external factors on the performance of server 110.

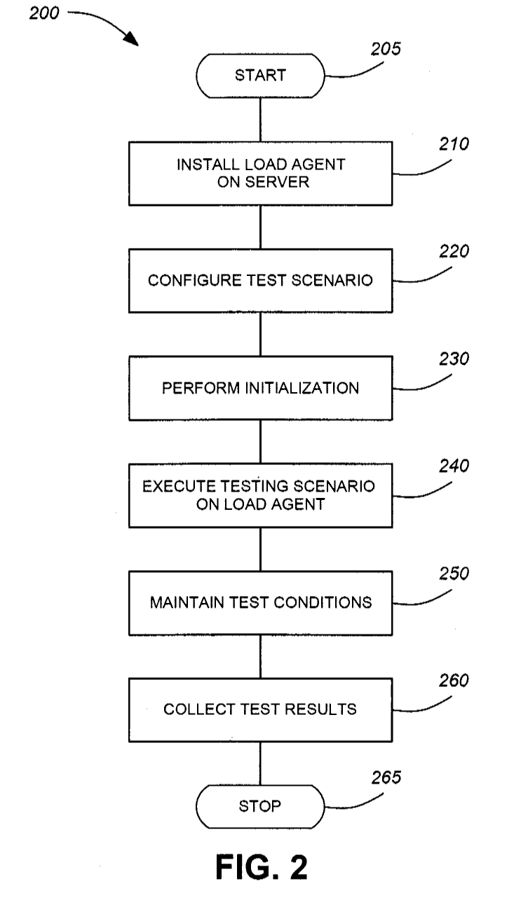

FIG. 2 is a flowchart showing the steps of an exemplary server load testing method 200. Exemplary method 200 starts in step 205 and proceeds to step 210, where load agent 130 is installed on server 110. Alternatively, a plurality of load agents 130 may be installed on each of a plurality of servers 110. It should be apparent that load agent 130 may be implemented and configured in any manner known to those of skill in the art, including, but not limited to, preconfigured software, scripts, and web services.

After installation of load agent 130 in step 210, exemplary method 200 proceeds to step 220, where a user configures the test scenario. More particularly, in various exemplary embodiments, an operator directs agent controller 120 to send testing parameters to load agent 130. Agent controller 120 merely manages the operation of load agent 130 and does not produce the load on server 110. Alternatively, in various exemplary embodiments, a user directly enters testing parameters into load agent 130, without intermediate processing by agent controller 120.

The test scenario of step 220 provides load levels that are settable, maintainable, and controllable. These load levels reflect parameters on server 110 that can impact the overall performance of system 100. Thus, loads may simulate CPU usage, memory usage, input/output bandwidth to a storage disc or disk, input/output bandwidth to a network, data transmission/reception rates to and from databases, and factors related to Web Service calls. It should be apparent, however, that any parameter or combination of parameters related to the performance of server 110 may be specified by the user.

After a user configures the test scenario in step 220, exemplary method 200 proceeds to step 230, where load agent 130 initializes the testing process. More particularly, in various exemplary embodiments, load agent 130 activates performance measurement tools 140 on server 110, such that performance measurement tools 140 are ready to monitor the given performance parameters and provide feedback to load agent 130 to maintain specified levels.

Performance gathering tools 160 may be started manually through alternate means or through plug-ins to agent controller 120 to ensure that load generation and results gathering are synchronized. While the tests are being executed, performance gathering tools 160 collect data related to the application performance under the generated load conditions.

Exemplary method 200 then proceeds to step 240, where load agent 130 executes the test scenario specified by the user. Thus, in various exemplary embodiments, load agent 130 triggers the consumption of resources to apply the load specified by the user. While the operation of load agent 130 simulates the operation of at least one performance characteristic on server 110, the simulated load is completely controllable to get exactly the load profile required for the particular testing. Thus, load agent 130 is self-contained and autonomous.

After beginning the test in step 240, exemplary method 200 proceeds to step 250, where load agent 130 maintains the test conditions. More particularly, load agent 130 regularly modifies the load on server 110 to keep the load substantially constant, as described further below with reference to FIG. 3. Thus, for example, load agent 130 may generate CPU load by creating a new thread when the CPU load is below the predetermined level, while stopping an existing thread when the CPU load rises above the predetermined level. As another example, load agent 130 may simulate memory load by initializing empty data structures when memory usage is below the predetermined level, while deleting the data structures when memory usage rises above the predetermined level.

In various exemplary embodiments, load agent 130 may conduct a multi-part test according to parameters specified by the user. As an example, a user may desire to simulate CPU usage of a first percentage during a first time period, while increasing CPU usage during a second time period. Accordingly, load agent 130 may read the user's parameters and adjust the specified load depending on the value specified for each time period. It should be apparent that any number of time periods and durations may be executed.

In step 260, results of the test are collected for further processing. Consequently, the server load testing will produce quantifiable results that accurately simulate the effect of selected factors on the normal operation of server 110. Thus, various exemplary embodiments provide a precise prediction of how server 110 will perform when placed under a user-configurable load, thereby allowing precise testing and testing under definable conditions that was not previously possible. Exemplary method 200 then proceeds to step 265, where exemplary method 200 stops.

FIG. 3 is a flowchart showing implementation of a feedback loop within the process of FIG. 2. It should be apparent that, in various exemplary embodiments, method 300 is executed in conjunction with step 250 of FIG. 2 to maintain the current load on server 110. Exemplary method 300 starts in step 305 and proceeds to step 310, where load agent 130 determines the current load on server 110 through performance measurement tools 140. Thus, in various exemplary embodiments, performance measurement tools 140 provide current values for each of the specified performance parameters to load agent 130.

Exemplary method 300.then proceeds to step 320, where load agent 130 determines whether the server load is above the threshold specified by the user. More particularly, load agent 130 compares the current value determined in step 310 to the threshold specified by the user when initializing the test. It should be apparent that step 320 may be performed multiple times when the user has specified more than one load parameter.

When, in step 320, load agent 130 determines that the current load is at or below the threshold specified by the user, exemplary method 300 proceeds to step 330. In step 330, load agent 130 increases the load on server 110. Thus, load agent 130 may, for example, start a new thread, create new data structures in memory, or initiate disk I/O operations. This operation will occur many times per second in order to ensure that the server load is dynamically controlled. As this test is executed more frequently, peripheral CPU load on the server will be greater, but the load control will also be more accurate. It is for this reason that the period for checking the current load is configurable by agent controller 120 or on load agent 130 as either a time interval between checking or as a function of maximum amount of CPU load consumable by load agent 130, independent of the load it is generating.

When, in step 320, load agent 130 determines that the current load is above the threshold specified by the user, exemplary method 300 proceeds to step 340. In step 340, load agent 130 decreases the load on server 110. Thus, load agent 130 may, for example, stop a thread, delete data structures from memory, or stop disk I/O operations. It should be noted that these functions only extend to load elements generated by the load agent 130. Load agent 130 is not capable of removing load that it did not generate.

After increasing the load in step 330 or decreasing the load in step 340, exemplary method 300 proceeds to step 350, where load agent 130 determines whether the current test has been completed. More particularly, load agent 130 accesses the parameters specified by the user to determine the amount of time the test is to be performed, the end time, or any other parameter used to signal the end of testing.

When in step 350, load agent 130 determines that the test scenario is not yet finished, exemplary method 300 proceeds to step 310, where load agent 130 again determines the current load on server 110. Alternatively, when in step 350, load agent 130 determines that the test is complete based on the elapsed time, user input, or another signal; exemplary method 300 proceeds to step 355, where exemplary method 300 stops.

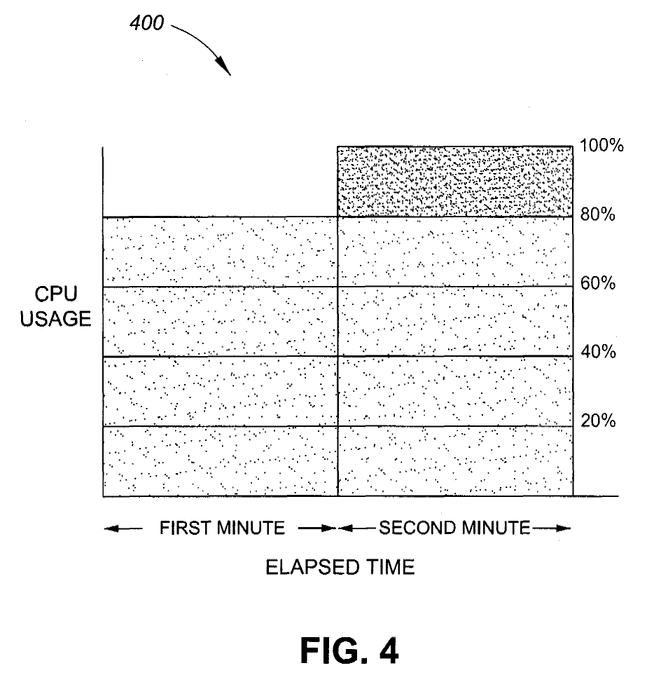

FIG. 4 shows an exemplary CPU usage test 400. As described above, load agent 130 may be used to test the performance of server 110 when the CPU of server 110 is at a user-specified level of usage. CPU usage test 400 illustrates an example of a test of server 110 when the CPU of server 110 is maintained at a first level for one minute, followed by a second level for another minute. More particularly, load agent 130 first sets and maintains CPU usage at approximately 80% for one minute. During this period, once the load reaches the 80% threshold, load agent 130 seeks to keep the CPU usage substantially constant.

Second, after concluding the 80% test, load agent 130 checks the case of full CPU usage. Instead of using an 80% threshold, load agent 130 resets usage to roughly 100%. During a second one-minute testing period, load agent 130 maintains the simulated CPU load at substantially 100%, thereby measuring a worst-case scenario.

Accordingly, a user of load agent 130 may determine the performance of server 110 during periods of high CPU usage. Thus, a user could use an external load generator to simultaneously test the response of a particular application while the CPU of server 110 is under a heavy load. This method provides a level of control not previously possible, using solely an external application for load generation.

It should be apparent that the test scenario of FIG. 4 is illustrated solely as an example. Accordingly, as described above, testing of server 110 may be directed to any performance parameter of server 110, including, but not limited to, CPU usage, memory usage, network load, and disk performance.

Furthermore, it should be apparent that, in various exemplary embodiments, the above-described load testing process for a server may be implemented in software as a computer program. The software may comprise a computer-readable medium encoded with instructions for server load testing. In particular, the instructions may be stored on a computer comprising at least one server.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of monitoring performance of a server, the method comprising:
placing a load agent on at least one server;
maintaining a load on the server using the load agent, wherein the load corresponds to at least one predetermined performance parameter of the server;
monitoring the at least one predetermined performance parameter on the server; and
gathering performance information while the load agent is monitoring the server.

2. The method of monitoring performance of a server according to claim 1, the method further comprising using an agent controller to configure a test scenario having the at least one predetermined parameter.

3. The method of monitoring performance of a server according to claim 2, the method further comprising using the agent controller to start the load agent.

4. The method of monitoring performance of a server according to claim 2, wherein the agent controller is located externally from the server.

5. The method of monitoring performance of a server according to claim 1, wherein the at least one predetermined parameter is CPU usage.

6. The method of monitoring performance of a server according to claim 5, wherein the load agent maintains the load on the server by starting and stopping executable threads.

7. The method of monitoring performance of a server according to claim 1,, wherein the at least one predetermined parameter is memory usage.

8. The method of monitoring performance of a server according to claim 7, wherein the at least one load agent maintains the load on the server by adding and deleting data structures from memory.

9. The method of monitoring performance of a server according to claim 1, wherein the at least one predetermined parameter is disk input and output performance.

10. The method of monitoring performance of a server according to claim 1, further comprising maintaining the at least one predetermined performance parameter at a first level during a first time period and at a second level during a second time period.

11. A system for load testing at least one server, the system comprising:
at least one server, each server comprising a load agent configured to maintain a load on the server based on parameters specified by a user; and
an agent controller configured to allow the user to externally control a load testing scenario on the server.

12. The system for load testing at least one server according to claim 11, wherein the load on the server corresponds to at least one predetermined performance parameter of the at least one server.

13. The system for load testing at least one server according to claim 12, the system further comprising performance measurement tools configured to gather information regarding the at least one predetermined performance parameter.

14. A computer-readable medium encoded with instructions for monitoring performance of a server, the computer-readable medium comprising:
instructions for placing a load agent on at least one server;
instructions for maintaining a load on the server using the load agent, wherein the load corresponds to at least one predetermined performance parameter of the server;
instructions for monitoring the at least one predetermined performance parameter on the server; and
instructions for gathering performance information while the load agent is monitoring-the server.

15. The computer-readable medium encoded with instructions for monitoring performance of a server according to claim 14, the computer-readable medium further comprising instructions for using an agent controller to configure a test scenario having the at least one predetermined parameter.

16. The computer-readable medium encoded with instructions for monitoring performance of a server according to claim 15, the computer-readable medium further comprising instructions for using the agent controller to start the load agent.

17. The computer-readable medium encoded with instructions for monitoring performance of a server according to claim 14, wherein the at least one predetermined parameter is CPU usage.

18. The computer-readable medium encoded with instructions for monitoring performance of a server according to claim 14, wherein the at least one predetermined parameter is memory usage.

19. The computer-readable medium encoded with instructions for monitoring performance of a server according to claim 14, wherein at least one predetermined parameter is disk input and output performance.

20. The computer-readable medium encoded with instructions for monitoring performance of a server according to claim 14, further comprising instructions for maintaining the predetermined performance parameter at a first level during a first time period and at a second level during a second time period.
